(19) United States
(12) Patent Application Publication
(10) Pub. No.: US 2010/0291390 A1
(43) Pub. Date: Nov. 18, 2010

(54) METHOD FOR COLORING OR FIGURING A SURFACE OF A SOFT MAGNET AND COLORING OR FIGURING MEDIUM MATERIAL USED IN THE METHOD

(76) Inventor: Chin-Mei FAN CHIANG, Taipei County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/777,548

(22) Filed: May 11, 2010

(30) Foreign Application Priority Data
May 14, 2009 (CN) 200910302324.X

(51) Int. Cl. B32B 37/14; B44C 1/24

(52) U.S. Cl. 428/409; 156/241

(57) ABSTRACT

A method for coloring or figuring a surface of a soft magnet includes steps of: preparing a soft magnet having a surface to be colored or figured; previously printing a color layer or a figure layer on a surface of a low-extensibility medium material; disposing an elastic attachment material layer on a surface of the color layer (or the figure layer) or the surface of the soft magnet; and stamping the medium material and the soft magnet to detach the color layer or the figure layer from the medium material and affix the color layer or the figure layer to the surface of the soft magnet via the elastic attachment material layer at high adhesion. During the stamping process, the soft elastic attachment material layer is expandable to absorb the expansion of the soft magnet to overcome the problem of poor precision existing in the conventional soft magnet printing operation.

### BACKGROUND OF THE INVENTION

1. Field of the Invention

The present invention relates generally to a method for coloring or figuring a surface of a soft magnet, and more particularly to a method for coloring or figuring a surface of a soft magnet by means of stamping. A color layer or a figure layer is previously disposed on a medium material. Then the medium material and the soft magnet are stamped to detach the color layer or the figure layer from the medium material and affix the color layer or the figure layer to the surface of the soft magnet at high adhesion. The method overcomes the problem of difficulty in directly printing a surface of a soft magnet with a color layer or a figure layer and the problem of difficulty in controlling the printing quality.

2. Description of the Related Art

A soft magnet is generally made from a complex material formed of ferric oxide powder mixed with rubber or plastic material. The complex material is at least once magnetized to become a flexible magnet with magnetic poles for attracting iron material. In order to avoid detachment of the magnetic powder, conventionally, a layer of polishing oil or paint or a figure layer 61 is sprayed onto the surface of the rubber magnet as shown in FIG. 1 or applied to the surface of the rubber magnet by means of halftone printing as shown in FIG. 2 to isolate the magnetic powder. However, the common adhesive or paint material has a surface activity quite different from that of the magnet. Therefore, after the magnet is printed with the paint material, it is necessary to dry the paint material for a long time. Moreover, in use, the surface-treated soft magnet is often bent at some specific parts. The paint layer at these parts is likely to crack or peel off from the magnet to deteriorate the appearance of the magnet.

In addition, the surface of the rubber magnet often has a dark brown color due to the composition of ferric oxide. Conventionally, a layer of color or paint is printed or coated on the surface of the rubber magnet to change the color thereof. However, the molecules of the rubber magnet (ferric oxide) are quite different from those of the common paint material in structure and activity. Besides, in the entire texture of the rubber magnet, there is neither any void nor any fiber tissue for containing dye or paint material. Therefore, it is hard for the dye or the color (paint) to directly attach to the magnet. Even if the color is affixed to the surface of the magnet, after a period of use, the color layer is still likely to crack or peel off from the surface of the magnet.

Also, the soft magnet is made of a soft elastic material with non-uniform extensibility. Therefore, when the surface of the soft magnet is colored or printed by means of a printing or roll machine, it is difficult to uniformly control the expansion of the material. As a result, after printed, the surface of the soft magnet often has a non-uniform color as a whole. To print a colorful picture on the surface of the soft magnet, it is necessary to repeatedly back and forth stamp multiple color layers onto the surface of the soft magnet to form a complete picture. Each stamping operation causes a non-uniform expansion of the material. As a result, the respective color layers can be hardly precisely aligned with each other. Such product can hardly meet the industrial precision requirement and thus cannot be practically used. Some manufacturers provide a measure for solving the above problems. According to this measure, a fiber texture (such as a fabric) is previously disposed on the surface of the magnet material. Then the fiber texture is printed with characters or figures by means of a sublimation dye to avoid detachment of the characters or the figures. However, in the case that the fiber texture is peeled off from the surface of the magnet material, the sublimation dye will detach from the surface of the magnet material. Therefore, the surface of the magnet still cannot be securely colored or figured with such measure.

In addition, the soft magnet has a very dark color itself, which will absorb the colority of the color material to a great extent. Therefore, when coloring or figuring the surface of the soft magnet in a conventional printing manner, the saturation of the printed soft magnet is very strictly required so that the applicable color is quite limited. As a result, in general, the surface of the soft magnet can be simply printed with a monotonous pattern (such as a nonsolid figure without decay effect) or even a monocolor figure. Accordingly, the conventional printing technique can be hardly widely applied to various soft magnet products. Therefore, it has become a critical issue in this field to securely and precisely color or figure the surface of the soft magnet and enhance the adhesion of the color (paint) material to the soft magnet.

Some manufacturers have provided an improved measure for coloring or figuring the surface of the soft magnet. According to this measure, an attachment medium material 62 such as a colored or figured paper, PP composite paper, PVC facial layer or PET facial layer is affixed to the surface of the rubber magnet 60 via an adhesive by means of a processing apparatus. In this case, the surface of the rubber magnet 60 can be colored or figured on one hand and the magnetic powder can be isolated on the other hand. However, it is hard and troublesome to manufacture and laminate the colored or figured paper on the surface of the rubber magnet. Moreover, both the material cost and the processing cost are quite high. Furthermore, for keeping a desired strength in lamination, the medium material 62 must have a considerable thickness. As a result, the laminated magnet product can be hardly slimmed and softened. Also, the medium material 62 has an extensibility different from that of the soft magnet. Therefore, in use, the medium material 62 tends to peel off from the soft magnet to locally crimp or blister the surface of the product. This apparently and seriously deteriorates the appearance of the product.

Therefore, it is necessary to provide a measure for enhancing the stability (inextensibility) and the adhesion of the color layer or the figure layer and minimizing the affection of the non-uniform expansion of the soft magnet on the color layer or the figure layer. By means of this measure, the surface of the soft magnet can be more securely colored or figured to overcome the problem of poor printing quality existing in the prior art.

### SUMMARY OF THE INVENTION

It is therefore a primary object of the present invention to provide a method for coloring or figuring a surface of a soft magnet. The method includes steps of: preparing a soft and low-extensibility sheet-like medium material made of, such as PVC, PET or PP material; previously disposing a desired color layer or a figure layer on at least one surface of the sheet-like medium material to form a removable layer; preparing a soft magnet having at least one surface to be printed; disposing an elastic attachment material layer on the removable layer or the surface to be printed, the elastic attachment material layer having an activity similar to that of the soft magnet and that of the color or figure layer; and overlapping and stamping the sheet-like medium material and the soft magnet with the removable layer facing the surface to be printed so as to detach the removable layer from the surface of the sheet-like medium material and affix the removable layer to the surface to be printed via the elastic attachment material layer. According to the above method, the surface of the soft magnet can be quickly and securely colored or figured.

It is a further object of the present invention to provide the above method in which the removable layer is previously disposed on the surface of the low-extensibility sheet-like medium material so as to ensure that during the printing process, the color or figure layer (removable layer) can be printed at a high precision under control due to the high stability of the medium material. Then the stably formed removable layer can be further precisely and stably transferred and stamped onto the surface of the soft magnet at one time. Accordingly, the problems of non-uniform chromatography and poor precision that exist in the conventional method of direct stamping are overcome.

It is still a further object of the present invention to provide the above method in which when the removable layer is transferred and stamped onto the surface of the soft magnet, the non-uniform expansion of the soft magnet due to the stamping pressure can be absorbed or eliminated by the soft elastic attachment material layer to minimize or even eliminate the affection on the removable layer. Therefore, the surface of the soft magnet can be more easily and stably colored or figured at high precision. In this case, the product can meet the industrial precision requirement and be practically used.

It is still a further object of the present invention to provide the above method in which the surface to be printed is previously surface-treated to enhance the adhesion of the elastic attachment material layer to the surface to be printed. Accordingly, the removable layer can be more securely bonded with the soft magnet via the elastic attachment material layer and the possibility of detachment or peeling of the removable layer from the surface is minimized.

In the above method, before the stamping operation, the soft magnet or the sheet-like medium material or the entire processing environment is previously heated with a heating device and then the stamping operation is performed.

In the above method, the input or output speed and transmission tension of the soft magnet or the sheet-like medium material with the removable layer are strictly monitored and regulated so as to stabilize the input or output speed during the stamping process. Therefore, the stretching or crimping of the product due to unstable transmission speed during the stamping process can be eliminated to ensure high precision and good quality of the stamped color or figure layer.

The present invention can be best understood through the following description and accompanying drawings, wherein:

### BRIEF DESCRIPTION OF THE DRAWINGS

FIG. 1 is a view showing that a polishing oil or color (paint) is sprayed onto the surface of a soft magnet in a conventional processing process;

FIG. 2 is a view showing that a polishing oil or color (paint) is applied to the surface of a soft magnet by means of halftone printing or prototype printing in a conventional processing process;

FIG. 3 is a view showing that a colored facial layer is adhered to the surface of a soft magnet in a conventional processing process;

FIG. 4 is a perspective view of the sheet-like medium material of the present invention;

FIG. 4A is a sectional view of a first embodiment of the sheet-like medium material of the present invention according to FIG. 4;

FIG. 4B is a sectional view of a second embodiment of the sheet-like medium material of the present invention according to FIG. 4;

FIG. 5 is a perspective view showing the stamping operation of the present invention;

FIG. 6 is a sectional view showing the stamping operation of the first embodiment of the sheet-like medium material of the present invention; and

FIG. 7 is a sectional view showing the stamping operation of the second embodiment of the sheet-like medium material of the present invention.

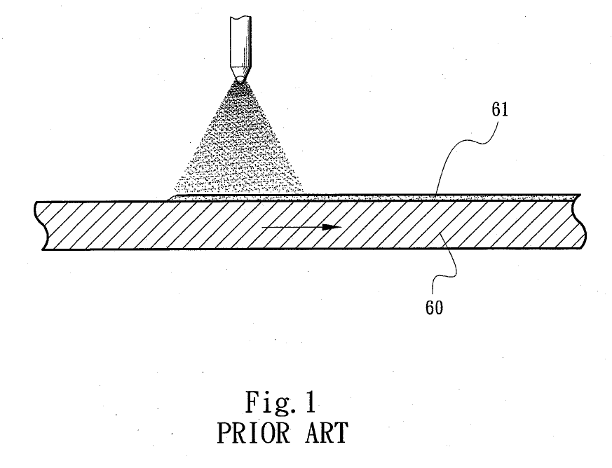

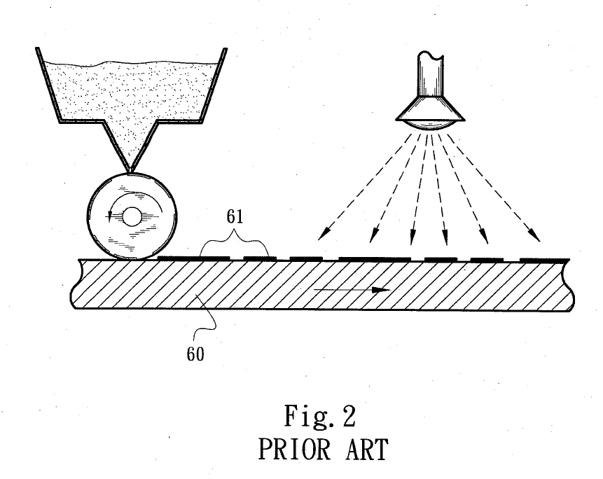

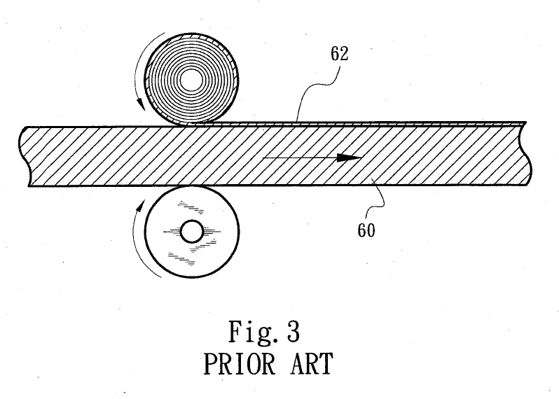

### DETAILED DESCRIPTION OF THE PREFERRED EMBODIMENTS

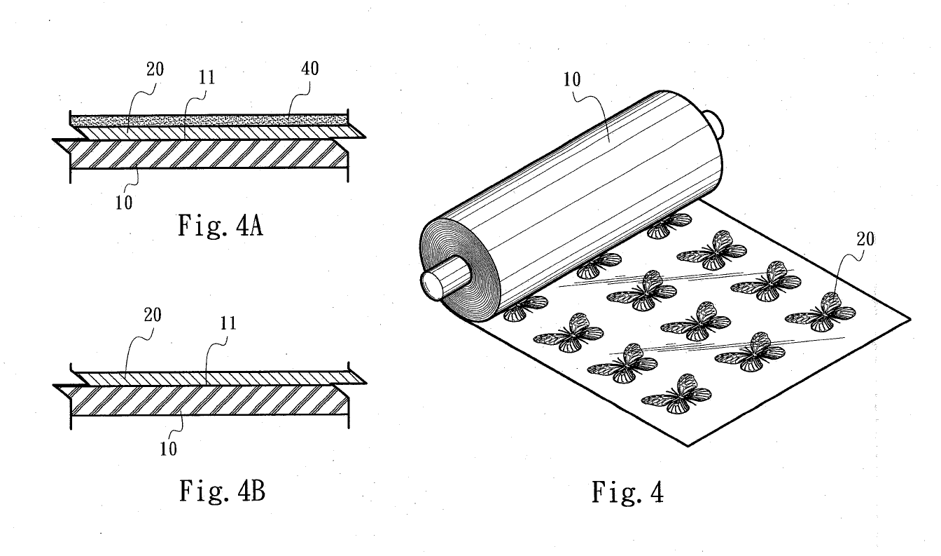

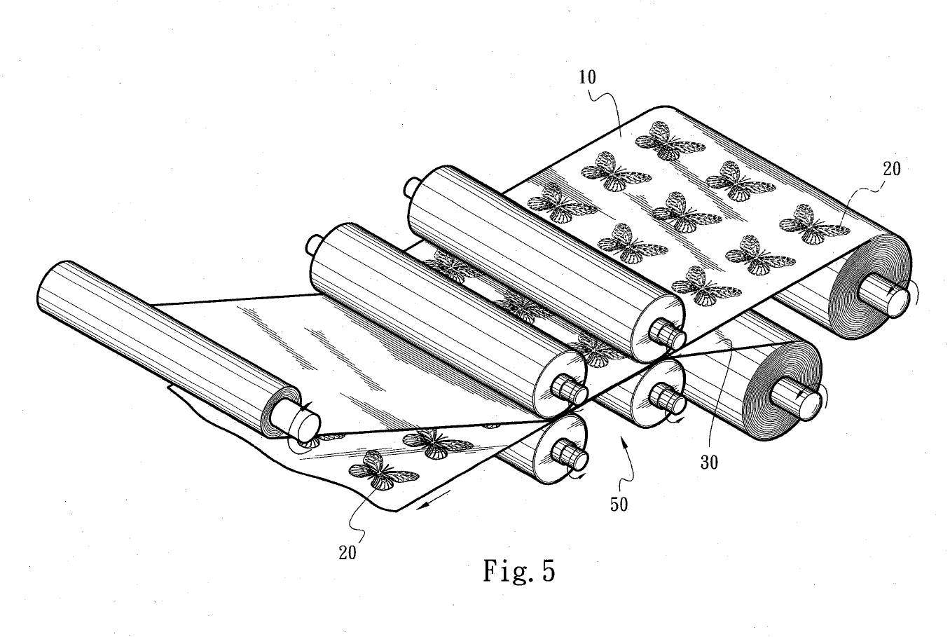

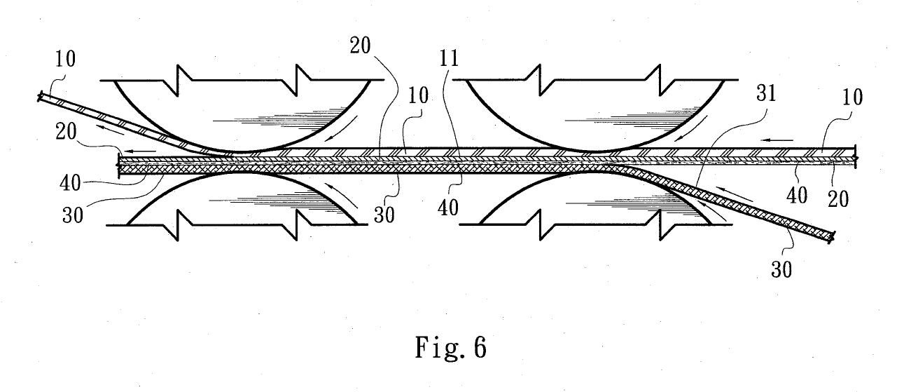

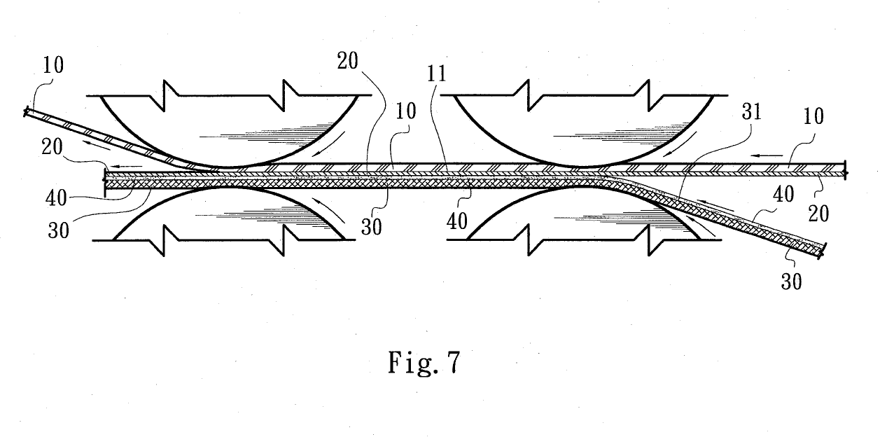

Please refer to FIGS. 4 to 7. According to the present invention, a color layer is applied to or a figure layer is printed on at least one surface 11 of a soft and low-extensibility sheet-like medium material 10 as a removable layer 20.

A soft magnet 30 having at least one surface 31 to be printed is provided. An activator is added into the material of the surface 31. Alternatively, the surface 31 is surface-treated (such as arc-treated, thermally treated or surface-roughened). Accordingly, the surface 31 to be printed can be firmly bonded with an elastic attachment material. The elastic attachment material can be made from a ground mixture of a polymer resin such as EVA, TPR, polyolefin or polyamide, a material with good ink-absorptivity and an adhesion promoter.

The elastic attachment material is sandwiched between the removable layer 20 and the surface 31 to be printed to form an elastic attachment material layer 40. The elastic attachment material layer 40 can be previously applied onto the removable layer 20 or the surface 31 to be printed. Then the soft magnet 30 and the sheet-like medium material 10 are together fed into a stamping device 50 with the surface 11 with the removable layer 20 facing the surface 31 to be printed. The stamping device 50 can be a thermal stamping device for continuously or discontinuously stamping the removable layer 20 on the surface 31 to be printed. In this embodiment, the removable layer 20 is continuously stamped on the surface 31 to be printed. Accordingly, the removable layer 20 can be detached from the surface 11 of the sheet-like medium material 10 and affixed to the surface 31 by means of the adhesion of the elastic attachment material layer 40. (In the case that the surface 11 of the sheet-like medium material 10 is a releasable surface, the stamping operation can be facilitated). The sheet-like medium material 10 has a low extensibility so that the stamping operation can be performed in a heating condition or the condition that the elastic attachment material layer 40 is not solidified. During the stamping process, the removable layer 20 can keep stable and undeformed. In the conventional stamping operation, it is necessary to repeatedly back and forth perform the multilayer chromatographic operation. In contrast, according to the present invention, at the preliminary stage of the printing process, the removable layer 20 can be previously painted or printed on the sheet-like medium material 10 in a stable and solidified state to present a final color or picture. Therefore, the problems of non-uniform chromatography and misalignment between the respective color layers can be obviated. During the stamping process, the expansion of the soft magnet 30 due to the stamping pressure can be mostly or completely absorbed, cushioned or eliminated by the soft elastic attachment material layer 40 without directly or indirectly acting on the removable layer 20. In other words, although the soft magnet 30 may unevenly expand during the stamping process, the expansion of the soft magnet 30 can only act on the very soft elastic attachment material layer 40 without traversing the elastic attachment material layer 40 to act on the removable layer 20. After the soft magnet 30 is relieved or released from the stamping pressure, the soft magnet 30 will restore to its original unexpanded state before the elastic attachment material layer 40 is fully solidified. Even if the soft magnet 30 is not fully restored to its original unexpanded state, the remainder expansion amount of the soft magnet 30 can be absorbed by the soft elastic attachment material layer 40. Accordingly, the action on the removable layer 20 can be effectively reduced or totally eliminated. Therefore, the product of the present invention is free from any shortcoming existing in the conventional stamping operation. Moreover, the removable layer 20 is isolated from the soft magnet 30 by the elastic attachment material layer 40. Therefore, the problem of insufficient saturation due to affection of the prime color of the magnet material is apparently improved. This avoids unstable color toning and facilitates the control of coloration.

Furthermore, during the stamping process, the input or output speed and tension can be strictly controlled to input and output the sheet-like medium material 10 and the soft magnet 30 and the product at the same speed. In this case, the materials are prevented from being transferred under non-uniform tension and thus the printing stability can be enhanced to ensure good quality of the product.

In addition, when input for stamping, the soft magnet 30 or the sheet-like medium material 10 or the entire processing environment can be heated to further increase the ratio of good products.

In conclusion, the present invention overcomes the problem of poor precision that exists in the conventional soft magnet printing operation. With the present invention, the soft magnet can be precisely colored or figured.

The above embodiments are only used to illustrate the present invention, not intended to limit the scope thereof. Many modifications of the above embodiments can be made without departing from the spirit of the present invention.

What is claimed is:

1. A medium material for coloring or figuring a surface of a soft magnet, comprising a sheet-like medium material, a color layer being applied to or a figure layer being printed on at least one surface of the sheet-like medium material as a removable layer, whereby by means of stamping, the removable layer can be detached from the surface of the sheet-like medium material and affixed to a surface of the soft magnet, which surface is to be printed.

2. The medium material for coloring or figuring the surface of the soft magnet as claimed in claim 1, wherein an elastic attachment material layer is disposed on the removable layer.

3. The medium material for coloring or figuring the surface of the soft magnet as claimed in claim 1, wherein an elastic attachment material layer is disposed on the surface to be printed.

4. The medium material for coloring or figuring the surface of the soft magnet as claimed in claim 1, wherein the surface of the sheet-like medium material with the removable layer is a releasable surface.

5. The medium material for coloring or figuring the surface of the soft magnet as claimed in claim 2, wherein the elastic attachment material layer is made from a thermoplastic elastic attachment material.

6. The medium material for coloring or figuring the surface of the soft magnet as claimed in claim 3, wherein the elastic attachment material layer is made from a thermoplastic elastic attachment material.

7. The medium material for coloring or figuring the surface of the soft magnet as claimed in claim 2, wherein the elastic attachment material layer is made from a mixture of a polymer resin, a material with good ink-absorptivity and an adhesion promoter.

8. The medium material for coloring or figuring the surface of the soft magnet as claimed in claim 3, wherein the elastic attachment material layer is made from a mixture of a polymer resin, a material with good ink-absorptivity and an adhesion promoter.

9. The medium material for coloring or figuring the surface of the soft magnet as claimed in claim 5, wherein the elastic attachment material layer is made from a mixture of a polymer resin, a material with good ink-absorptivity and an adhesion promoter.

10. The medium material for coloring or figuring the surface of the soft magnet as claimed in claim 7, wherein the elastic attachment material layer is made from a mixture of a polymer resin, a material with good ink-absorptivity and an adhesion promoter.

11. A method for coloring or figuring a surface of a soft magnet, comprising steps of:
preparing a low-extensibility sheet-like medium material;
disposing a color layer or a figure layer on at least one surface of the sheet-like medium material to form a removable layer;
preparing a soft magnet having at least one surface to be printed;
disposing an elastic attachment material layer between the removable layer and the surface to be printed; and
overlapping and stamping the sheet-like medium material and the soft magnet with the removable layer facing the surface to be printed so as to stamp the removable layer onto the surface to be printed, whereby the removable layer is detached from the surface of the sheet-like medium material and affixed to the surface to be printed via the elastic attachment material layer.

12. The method for coloring or figuring the surface of the soft magnet as claimed in claim 11, wherein the elastic attachment material layer is previously applied to the removable layer and then the sheet-like medium material and the soft magnet are stamped to affix the removable layer to the surface to be printed via the elastic attachment material layer.

13. The method for coloring or figuring the surface of the soft magnet as claimed in claim 11, wherein the elastic attachment material layer is previously applied to the surface to be printed and then the sheet-like medium material and the soft magnet are stamped to affix the removable layer to the surface to be printed via the elastic attachment material layer.

14. The method for coloring or figuring the surface of the soft magnet as claimed in claim 11, wherein the surface of the sheet-like medium material with the removable layer is a releasable surface.

15. The method for coloring or figuring the surface of the soft magnet as claimed in claim 11, wherein the removable layer is formed of a color layer overlaid on the surface of the sheet-like medium material.

16. The method for coloring or figuring the surface of the soft magnet as claimed in claim 12, wherein the removable layer is formed of a color layer overlaid on the surface of the sheet-like medium material.

17. The method for coloring or figuring the surface of the soft magnet as claimed in claim 13, wherein the removable layer is formed of a color layer overlaid on the surface of the sheet-like medium material.

18. The method for coloring or figuring the surface of the soft magnet as claimed in claim 14, wherein the removable layer is formed of a color layer overlaid on the surface of the sheet-like medium material.

19. The method for coloring or figuring the surface of the soft magnet as claimed in claim 11, wherein the removable layer is formed of a figure layer printed on the surface of the sheet-like medium material.

20. The method for coloring or figuring the surface of the soft magnet as claimed in claim 12, wherein the removable layer is formed of a figure layer printed on the surface of the sheet-like medium material.

21. The method for coloring or figuring the surface of the soft magnet as claimed in claim 13, wherein the removable layer is formed of a figure layer printed on the surface of the sheet-like medium material.

22. The method for coloring or figuring the surface of the soft magnet as claimed in claim 14, wherein the removable layer is formed of a figure layer printed on the surface of the sheet-like medium material.

23. The method for coloring or figuring the surface of the soft magnet as claimed in claim 11, wherein an activator is added into a material of the surface to be printed for firmly bonding the surface to be printed with the elastic attachment material layer.

24. The method for coloring or figuring the surface of the soft magnet as claimed in claim 12, wherein an activator is added into a material of the surface to be printed for firmly bonding the surface to be printed with the elastic attachment material layer.

25. The method for coloring or figuring the surface of the soft magnet as claimed in claim 13, wherein an activator is added into a material of the surface to be printed for firmly bonding the surface to be printed with the elastic attachment material layer.

26. The method for coloring or figuring the surface of the soft magnet as claimed in claim 11, wherein the surface to be printed is surface-treated by means of at least one of the treatments of arc treatment, thermal treatment and surface roughening, whereby the surface to be printed can be firmly bonded with the elastic attachment material layer.

27. The method for coloring or figuring the surface of the soft magnet as claimed in claim 12, wherein the surface to be printed is surface-treated by means of at least one of the treatments of arc treatment, thermal treatment and surface roughening, whereby the surface to be printed can be firmly bonded with the elastic attachment material layer.

28. The method for coloring or figuring the surface of the soft magnet as claimed in claim 13, wherein the surface to be printed is surface-treated by means of at least one of the treatments of arc treatment, thermal treatment and surface roughening, whereby the surface to be printed can be firmly bonded with the elastic attachment material layer.

29. The method for coloring or figuring the surface of the soft magnet as claimed in claim 11, wherein the stamping operation is carried out in the form of thermal stamping.

30. The method for coloring or figuring the surface of the soft magnet as claimed in claim 12, wherein the stamping operation is carried out in the form of thermal stamping.

31. The method for coloring or figuring the surface of the soft magnet as claimed in claim 13, wherein the stamping operation is carried out in the form of thermal stamping.

32. The method for coloring or figuring the surface of the soft magnet as claimed in claim 11, wherein the stamping operation is carried out in the condition that the elastic attachment material layer is soft and not solidified.

33. The method for coloring or figuring the surface of the soft magnet as claimed in claim 11, wherein in the stamping operation, input or output speed and tension of at least one of the sheet-like medium material and the soft magnet are synchronously controlled.

34. The method for coloring or figuring the surface of the soft magnet as claimed in claim 11, wherein in the stamping operation, at least one of the soft magnet and the sheet-like medium material is heated.

35. The method for coloring or figuring the surface of the soft magnet as claimed in claim 29, wherein in the stamping operation, at least one of the soft magnet, the sheet-like medium material and a processing environment is heated.

36. The method for coloring or figuring the surface of the soft magnet as claimed in claim 33, wherein in the stamping operation, at least one of the soft magnet, the sheet-like medium material and a processing environment is heated.

37. The method for manufacturing the medium material for coloring or figuring the surface of the soft magnet as claimed in claim 11, wherein the elastic attachment material layer is made from a thermoplastic elastic attachment material.

38. The method for manufacturing the medium material for coloring or figuring the surface of the soft magnet as claimed in claim 11, wherein the elastic attachment material layer is made from a mixture of a polymer resin, a material with good ink-absorptivity and an adhesion promoter.

39. The method for manufacturing the medium material for coloring or figuring the surface of the soft magnet as claimed in claim 11, wherein the elastic attachment material layer is made from a mixture of a polymer resin, a material with good ink-absorptivity and an adhesion promoter.

40. A method for manufacturing a medium material for coloring or figuring a surface of a soft magnet, comprising steps of:
preparing a low-extensibility sheet-like medium material; and
disposing a color layer or a figure layer on at least one surface of the sheet-like medium material to form a removable layer.

41. The method for manufacturing the medium material for coloring or figuring the surface of the soft magnet as claimed in claim 40, wherein an elastic attachment material layer is disposed on a surface of the removable layer.

42. The method for manufacturing the medium material for coloring or figuring the surface of the soft magnet as claimed in claim 40, wherein the elastic attachment material layer is made from a thermoplastic elastic attachment material.

43. The method for manufacturing the medium material for coloring or figuring the surface of the soft magnet as claimed in claim 41, wherein the elastic attachment material layer is made from a thermoplastic elastic attachment material.

44. The method for manufacturing the medium material for coloring or figuring the surface of the soft magnet as claimed in claim 40, wherein the elastic attachment material layer is made from a mixture of a polymer resin, a material with good ink-absorptivity and an adhesion promoter.

45. The method for manufacturing the medium material for coloring or figuring the surface of the soft magnet as claimed in claim 41, wherein the elastic attachment material layer is made from a mixture of a polymer resin, a material with good ink-absorptivity and an adhesion promoter.

46. The method for manufacturing the medium material for coloring or figuring the surface of the soft magnet as claimed in claim 42, wherein the elastic attachment material layer is made from a mixture of a polymer resin, a material with good ink-absorptivity and an adhesion promoter.

47. A soft magnet structure with a colored or figured surface, comprising a soft magnet and a removable layer formed of a color layer or a figure layer, the removable layer being detached from a medium material and affixed to at least one surface of the soft magnet by means of stamping.

48. The soft magnet structure with the colored or figured surface as claimed in claim 47, wherein an elastic attachment material layer is disposed between the removable layer and the surface of the soft magnet.

49. The soft magnet structure with the colored or figured surface as claimed in claim 48, wherein the elastic attachment material layer is made from a thermoplastic elastic attachment material.

50. The soft magnet structure with the colored or figured surface as claimed in claim 47, wherein the elastic attachment material layer is made from a mixture of a polymer resin, a material with good ink-absorptivity and an adhesion promoter.

51. The soft magnet structure with the colored or figured surface as claimed in claim 48, wherein the elastic attachment material layer is made from a mixture of a polymer resin, a material with good ink-absorptivity and an adhesion promoter.

52. The soft magnet structure with the colored or figured surface as claimed in claim 49, wherein the elastic attachment material layer is made from a mixture of a polymer resin, a material with good ink-absorptivity and an adhesion promoter.
